(19) United States
(12) Patent Application Publication
(10) Pub. No.: US 2017/0157873 A1
(43) Pub. Date: Jun. 8, 2017

(54) METHOD AND APPARATUS FOR ASSEMBLING A TIRE BLANK

(71) Applicants: COMPAGNIE GENERALE DES ETABLISSEMENTS MICHELIN, CLERMON-FERRAND (FR); Michelin Recherche et Technique S.A., GRANGES-PACCOT (FR)

(72) Inventors: HENRI HINC, Clermont-Ferrand (FR); MICHEL DRUET, Clermont-Ferrand (FR); MICHEL DEBOEUF, Clermont-Ferrand (FR); NICOLAS JAUNET, Clermont-Ferrand (FR); JEAN-MARIE DETTORRE, Clermont-Ferrand (FR)

(73) Assignee: COMPAGNIE GENERALE DES ETABLISSEMENTS MICHELIN, CLERMONT-FERRAND (FR)

(21) Appl. No.: 15/321,496

(22) PCT Filed: May 29, 2015
(86) PCT No.: PCT/EP2015/062027

§ 371 Date: Dec. 22, 2016

(30) Foreign Application Priority Data
Jun. 30, 2014 (FR) 1456169

(51) Int. Cl. B29D 30/38; B29D 30/22

(52) U.S. Cl. CPC B29D 30/38; B29D 30/22; B29D 2030/381; B29K 2105/10

(57) ABSTRACT

A method for manufacturing a tire involves successively performing steps that include: continuously converting a flat reinforcing strip into an undulating reinforcing strip; pressing peaks of waves of the undulating reinforcing strip one by one onto a surface of a tire blank that is driven in rotation by a drum about a drum axis; and winding the undulating reinforcing strip onto the tire blank. In the converting step, the flat reinforcing strip is converted into the undulating reinforcing strip in an immediate vicinity of the drum. The waves of the undulating reinforcing strip and movement of the peaks of the waves of the undulating reinforcing strip towards the surface of the tire blank extend in a plane substantially perpendicular to the drum axis.

The invention concerns the field of manufacturing tires for passenger vehicles or utility vehicles and relates more particularly to assembly methods for successively laying all of the component parts of such a tire without substantial variation in the laying diameter.

In these types of method, all of the operations for assembling the tire blank are carried out on a drum, the diameter of which preferably corresponds substantially to the inside diameter of the tire (commonly referred to as “rim seat diameter” with reference to the standard diameter of the rim on which the tire will be mounted during its use). Thus, not only the carcass, the beads and the sidewalls, but also the crown reinforcements and the tread can be laid on an assembly drum, the diameter of which corresponds substantially to the rim seat diameter. One advantage of these types of method is that they can make it possible to keep the tire blank on the same drum throughout its assembly. The complete blank can then be introduced directly into a vulcanizing mould, where it takes on its final outside diameter through the action of an internal pressure. An example of this type of method is given in the document FR1508652.

Shaping is the name given to the conversion undergone by the tire blank when it passes from its substantially tubular shape to the generally toroidal shape of a finished tire. During shaping, the central part of the blank, which corresponds to the crown of the tire, has its diameter increased through the action of an internal pressure, while the beads are kept at the initial diameter. The difference in circumference between the rim seat diameter and the shaped diameter is generally between 30% and 70% and, for example, commonly around 50% for a tire for a passenger vehicle.

One limitation of these methods comes from the fact that the crown reinforcements of tires for passenger vehicles or utility vehicles virtually systematically have circumferential hooping reinforcers, often known as “0° reinforcers”. The function of these 0° reinforcers is to strongly curb the circumferential expansion of the tire while it is being used, notably at high speed. The term 0° reinforcers is used even when they are laid in a helically wound manner and thus with a very slight helix angle. This helix angle is generally ignored and the effect of the hooping reinforcers is considered to be the same as if they were disposed in a plane strictly parallel to the equatorial plane of the tire. It will be understood that if they were laid on the blank prior to the shaping of the latter, these 0° reinforcers would prevent shaping.

Solutions to this impossibility are proposed for example in the documents U.S. Pat. No. 4,050,973 and U.S. Pat. No. 4,094,354.

The document U.S. Pat. No. 4,050,973 proposes that the 0° reinforcers be prepared and laid on the tire blank in an undulating form obtained by knitting the 0° reinforcers with threads that are shorter but fragile, these threads being broken during shaping. One problem with this method is clearly the complexity and slowness of preparing the knit. Another problem is the fact that additional threads are required, which are useless in the final product and which can also be harmful.

The document U.S. Pat. No. 4,094,354 proposes that the 0° reinforcers be prepared in the form of a double strip of rubber comprising both undulating 0° reinforcers and threads that are taut but fragile and are intended to be broken during shaping. One problem with this method is clearly the complexity of preparing the double strip and also the fact that useless or even harmful threads are introduced into the final product.

Thus, in spite of these propositions, the tire industry has not adopted this type of method for assembling the entire blank at the rim seat diameter in order to manufacture tires having 0° crown reinforcers and in particular in order to manufacture modern radial tires.

Therefore, the object of the invention is to overcome at least one of the disadvantages described above.

To this end, the invention proposes a method and an installation for preparing and laying, within the tire blank, a strip comprising longitudinal reinforcers, said strip being laid in an undulating form such that the length of the longitudinal reinforcers is very much greater than the laying length. The term “overlength” is used to denote the difference between the strip length effectively laid and the length that is travelled over the laying surface.

In the present application, the term “reinforcing strip” or “strip” denotes a narrow band of rubber including longitudinal reinforcers that is intended to be laid by being wound helically within the blank of a tire. The reinforcers can for example be cords or monofilaments that are made of steel, of an inorganic material (glass fibre or carbon fibre), of synthetic fibre or of textile material in a manner known per se in the field of tires. A strip comprises a plurality of reinforcers, for example between 3 and 10 reinforcers. Such a strip has a maximum width of around 15 to 20 mm across the total width of the hoop reinforcement. Also preferably, for the hoop reinforcement of a passenger vehicle tire, the strip has a maximum width of 11 mm. The winding comprises a plurality of turns, for example between 10 and 30 turns in order to form a complete hoop reinforcement.

The invention thus proposes a method for manufacturing a tire, said method successively comprising the steps of:
continuously converting a flat reinforcing strip into an undulating reinforcing strip,
pressing the peaks of the waves of the undulating strip one by one onto the surface of a tire blank that is driven in rotation by a drum about a drum axis,
winding the undulating strip onto the tire blank,
   wherein the flat reinforcing strip is converted into an undulating strip in the immediate vicinity of the drum, the waves of the undulating strip and the movement of the wave peaks towards the surface of the blank extending in a plane substantially perpendicular to the drum axis.

Preferably, the undulating strip is wound helically onto the tire blank so as to form, in a plurality of turns, a hoop reinforcement of the crown of the tire, the undulating strip having a given overlength allowing the blank to be shaped.

Also preferably, the method also comprises a step of stitching that consists in continuously folding down the waves of the undulating strip while the strip is being wound onto the blank, the movement of folding the waves down towards the surface of the blank being carried out in a plane substantially perpendicular to the drum axis.

Also preferably, the height of the waves is varied during winding.

The invention also proposes an installation for implementing such a method, said installation comprising a rotary drum that rotates about a drum axis, said drum being able to carry a tire blank, said drum being placed next to a device that is able to:
continuously convert a flat reinforcing strip into an undulating reinforcing strip,
press the peaks of the waves of the undulating strip one by one onto the surface of a tire blank that is driven in rotation by the drum.

Preferably, the device comprises:
a continuous transporter that is able to guide a plurality of fingers along a closed circuit, said fingers being able to bear against a first face of the strip,
a rotary support plate that rotates about a support plate axis, said rotary support plate bearing a plurality of rotary rollers having axes parallel to the support plate axis, said rollers being distributed in a circle substantially concentric with the support plate axis, said rollers being able to bear against a second face of the strip,
guide means for guiding the flat reinforcing strip entering the device,
means for synchronizing the rotation of the rotary support plate and the forward motion of the continuous transporter,
   the closed circuit having an intersecting portion in which the synchronizing means allow the fingers and the rollers to move in rotational movements in a common plane perpendicular to the support plate axis, the fingers and the rollers being interposed in said intersecting portion so as to impose waves on the strip that extend in said common plane.

Also preferably, the continuous transporter is a chain guided by an intersecting sprocket in the intersecting portion of the closed circuit.

Also preferably, the fingers are carried by the pins of the links of the chain.

Also preferably, the device also comprises a static strip diverter positioned in the intersecting portion in order to be able to divert the strip from the fingers, preferably at least a quarter turn after the start of the intersecting portion.

Also preferably, the device also comprises stitching means for stitching the undulating strip.

Also preferably, the device also comprises a motorized winch that is able to control the supply thereof with flat strip.

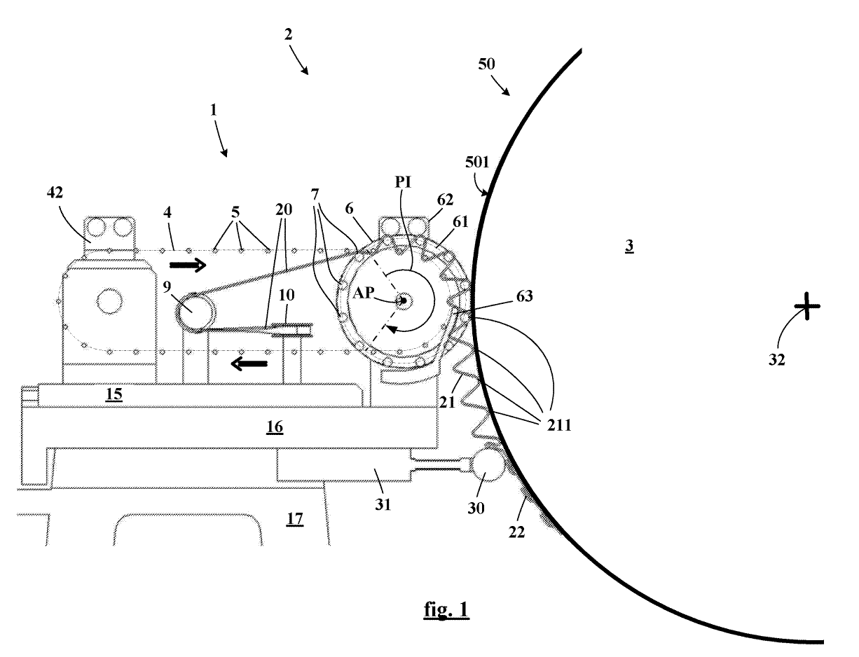

The following description makes it possible to more easily understand the method according to the invention and also the structure and operation of an installation according to preferred embodiments of the invention and on the basis of FIGS. 1 to 10, in which:

FIG. 1 is a schematic view showing the principle of the method of the invention and a first embodiment of an installation according to the invention during the use thereof,

FIG. 2 is a schematic perspective view of the device from FIG. 1,

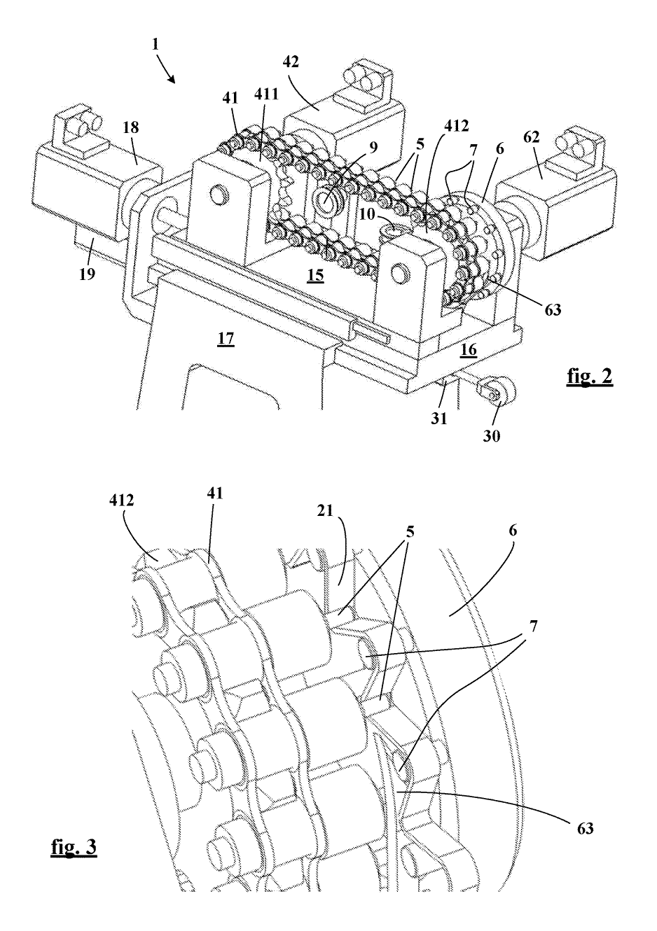

FIG. 3 is a detail view of the operation of the device from FIG. 1,

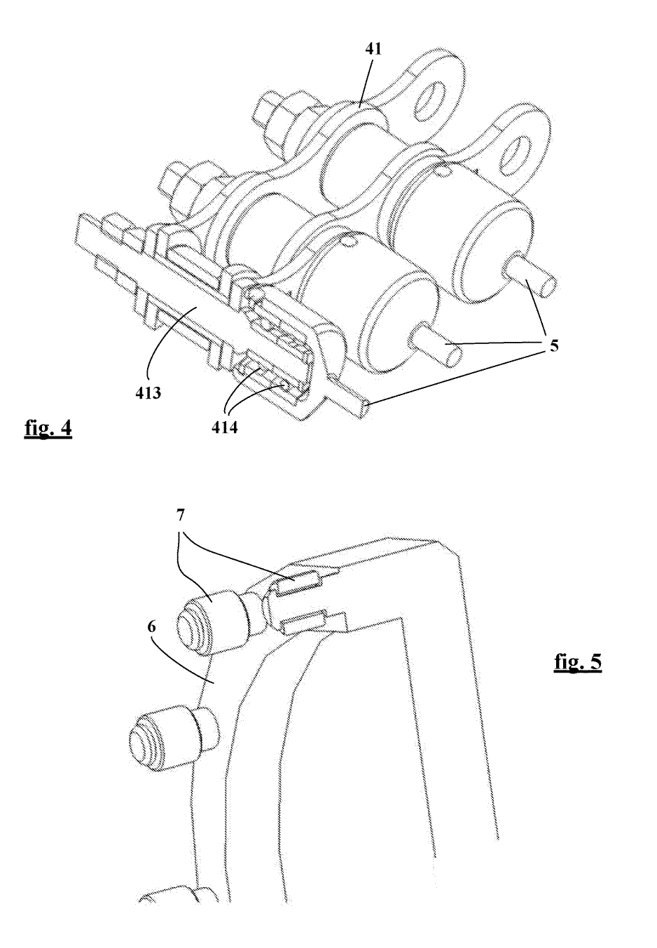

FIG. 4 is a cross-sectional view of an exemplary embodiment of the support for the fingers of the device from FIG. 1,

FIG. 5 is a cross-sectional view of an exemplary embodiment of the support for the rollers on the rotary support plate of the device from FIG. 1,

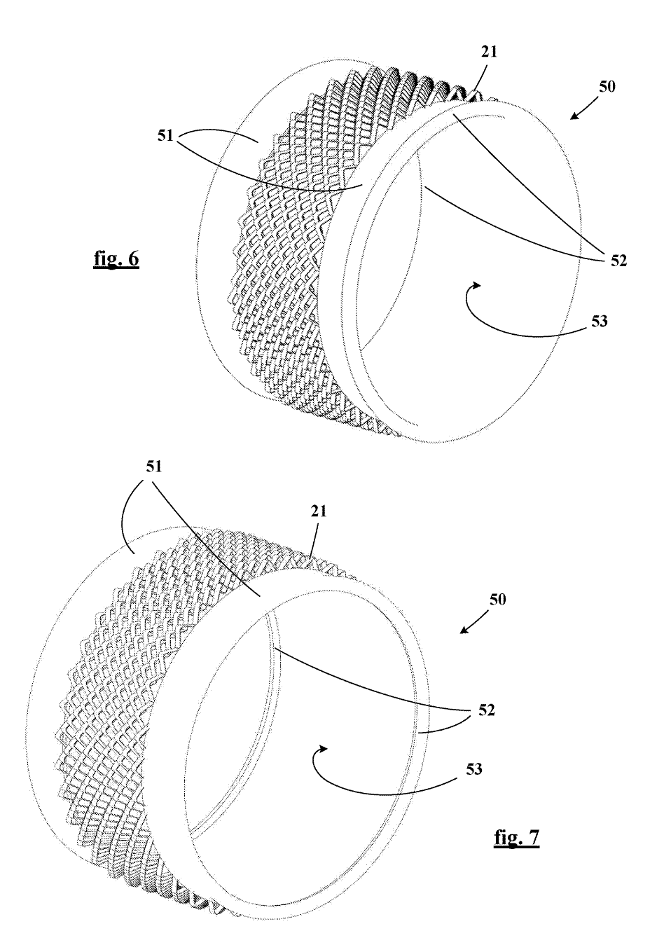

FIGS. 6 and 7 are schematic perspective views showing two similar examples of a tire blank obtained by the method of the invention,

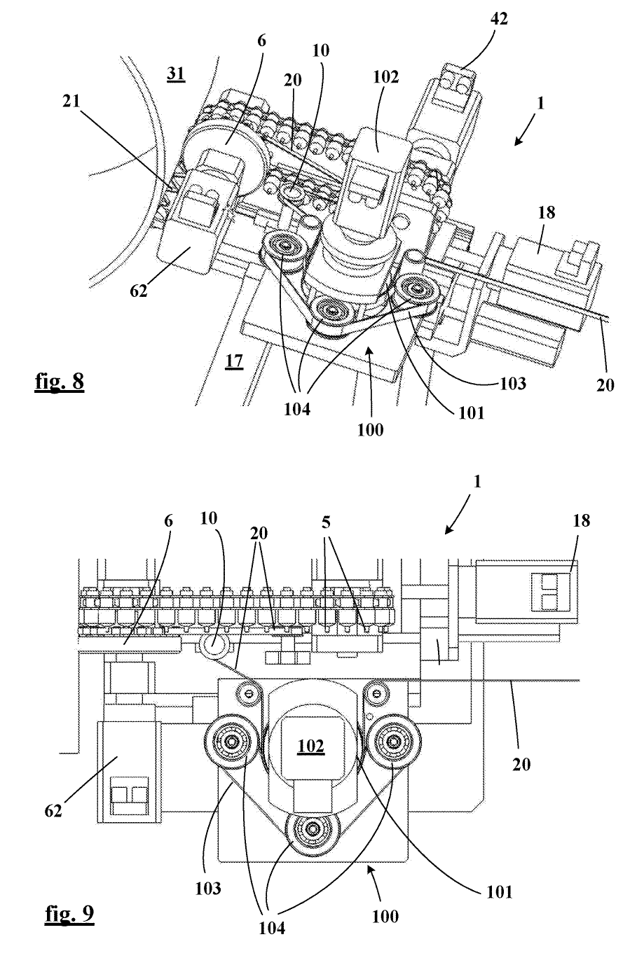

FIGS. 8 and 9 illustrate a perspective view and a top view of a preferred embodiment of the device from FIG. 1,

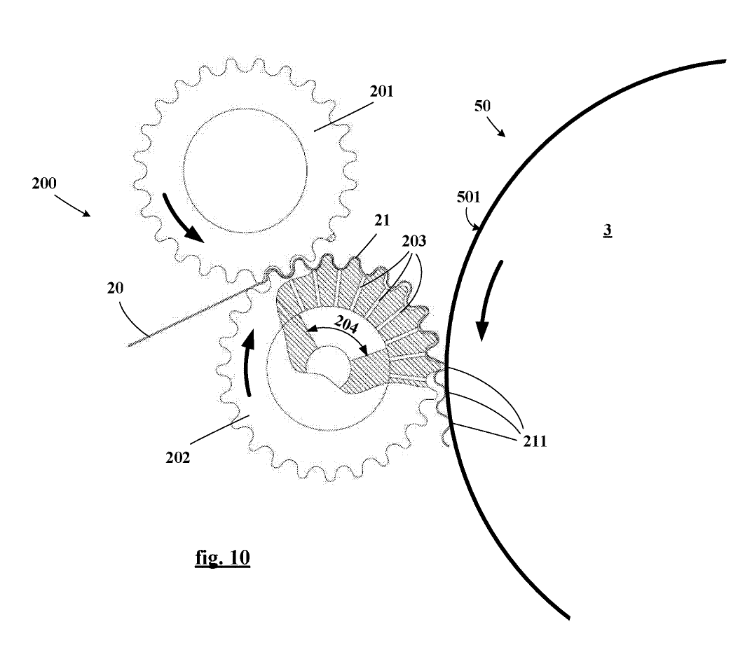

FIG. 10 is a schematic view showing the method of the invention implemented on a second embodiment of an installation according to the invention.

In the different figures, identical or similar elements bear the same references. Therefore, the description of the structure and the function of these identical or similar elements is not repeated systematically.

The essential principles of the method and of the installation according to the invention can be seen in FIG. 1.

The method of the invention is a substantially continuous method which consists first of all in converting a flat reinforcing strip 20 into an undulating strip 21 and then laying it in the undulating form on a tire blank 50. These two steps take place in succession and preferably immediately after one another. Gradually, a winding of several turns of this undulating strip is produced on the blank. The waves of the undulating strip 21 and the movement towards the surface of the blank extend in a plane perpendicular to the axis of the tire blank, that is to say a plane perpendicular to the axis 32 of the drum 3 which supports and controls the rotation of the blank 50. It will be understood that the winding is realized as a helix in a manner known per se in order to manufacture a hoop reinforcement over a given width, this width usually being defined with respect to the intended width of the tread of the tire.

Preferably, the method also comprises, as shown here, a stitching step that consists in converting the undulating strip 21 into a stitched undulating strip 22, that is to say a strip, the waves of which have been folded down onto the blank after having been laid thereon. It is clear from this figure that the length of the strip laid on the blank (and thus the length of the longitudinal reinforcers that it contains) is very much greater than the laying length that is travelled over the surface of the blank 50.

Therefore, the method of the invention does not involve storing or managing a semifinished intermediate product. Rather, the undulating strip is wound directly within the blank as soon as the step which gives it its undulating shape has been carried out.

In order to give the entire winding uniform stiffness, it may be preferable to wind the first and last turn of the strip without axial displacement and thus on itself. Similarly, in order to obtain a sufficient reinforcer density, it may be preferable to successively wind a plurality of hoop reinforcement layers according to the principle of the invention.

The installation 2 makes it possible to implement this method. It comprises the assembly drum 3 and a device for preparing and laying the strip. This device 1 makes it possible, firstly, to convert a flat reinforcing strip 20 in situ into an undulating strip 21 and, secondly, to lay the strip in the undulating form on a tire blank 50. Preferably, the device makes it possible, thirdly, to convert the undulating strip 21 into a stitched undulating strip 22, that is to say a strip, the waves of which have been folded down onto the surface 501 of the blank 50.

To this end, the device 1 comprises a closed circuit along which fingers 5 circulate in the direction indicated in the figure by the arrows. The fingers are guided along the circuit by an indexed continuous transporter 4, for example a chain or toothed belt. The continuous transporter is driven in this case by a geared transporter motor 42. A rotary support plate 6 carries rollers 7 that are distributed at its periphery in a circle 61 concentric with the axis of rotation AP of the rotary support plate. The rotation of the support plate is controlled by a geared support plate motor 62.

Synchronization means control the speed of the two geared motors such that the movement of the fingers 5 along the circuit is coordinated with the movement of the rollers 7 of the support plate, in particular in an intersecting portion PI in which the fingers and the rollers can thus move in a common plane perpendicular to the support plate axis AP and to the drum axis 32. The fingers 5 bear against the upper face of the strip, while the rollers 7 bear against the lower face of the strip. During operation of the device, it will be understood that the rollers of the support plate are interposed between the fingers and progressively force the strip to take on an undulating shape 21.

The device 1 is positioned facing the tire blank 50 carried by the rotary assembly drum 3 such that the rollers of the rotary support plate move, one after the other, towards the surface 501 of the blank. The operation of the above-described device is synchronized with the rotation of the drum. The peaks 211 of the waves of the undulating band 21 can then come into contact and be pressed, one by one, against the surface of the blank 501. The rubber strip can thus adhere to points of the moving surface of the blank and then be carried along thereby.

The device 1 preferably comprises a fixed strip diverter 63, the function of which is to axially release the strip 21 from the fingers once the undulating strip is connected to the blank. The strip is then carried along by the blank and is wound therein while being released from the control of the fingers and the rollers of the device. The strip diverter acts in the intersecting portion PI, preferably at least a quarter turn after the start of the latter.

Also preferably, stitching means 30 fold down the waves of the undulating strip 21 by pressing them against the surface of the blank. The stitched undulating strip 22 is then, better still, fixed in terms of its position and in terms of the longitudinal orientation of its reinforcers, thereby making it possible to ensure the best distribution of the overlength of the reinforcers on the circumference of the blank.

FIG. 2, in perspective, makes it possible to better see the constituent elements of this preferred embodiment of the installation. In particular, if FIGS. 1 and 2 are compared, it is easy to see the principle of the means which guide the flat strip entering the device. A guide pulley 9 positioned in the plane and inside the closed circuit of the transporter 4 guides the flat strip towards the intersecting portion PI of the fingers and the rollers. The guide pulley 9 receives the strip from a feed pulley 10 that is also positioned in the plane of the circuit of the fingers but oriented so as to receive the strip from the outside, for example from the rear in FIG. 1 in this embodiment. It is also possible to see that the strip 20 is twisted by around a quarter turn between the two pulleys.

FIG. 2 also clearly shows the driving principle of the fingers 5 by the continuous transporter 4, in this case in the form of a chain 41. The chain 41 circulates about two sprockets 411 and 412. Consequently, the closed circuit of the transporter 4 comprises two semicircular path portions about the two sprockets 411 and 412 and two rectilinear path portions between the two sprockets 411 and 412. The drive sprocket 411 is driven by the transporter motor 42. Advantageously, the design of the continuous transporter 4 with chains 41 and sprockets 411 and 412 makes it possible to relocate the transporter motor 42 with respect to the geared support plate motor 62. The intersecting sprocket 412 is driven in rotation by the chain and its only function is to guide the chain and thus to guide the fingers 5 with respect to the rollers 7 of the support plate 6. As discussed above, the movement of the chain should take place in a manner perfectly synchronized with the rotation of the support plate 6 bearing the rollers 7. This synchronization is ensured by the synchronizing means, for example by common control of the two electric motors 42 and 62. Alternatively, the intersecting sprocket 412 can be driven in rotation by the same motor as the rotary support plate. Since the sprocket 412 is not necessarily coaxial with the support plate axis, it can preferably be driven by way of an Oldham coupling or a shaft equipped with constant-velocity joints.

Thus, in the intersecting portion PI, the continuous transporter 4 affords a first rectilinear path portion within which the fingers 5 move in a rectilinear manner while the rollers 7 of the support plate 6 are interposed between these fingers 5, and then a semicircular path portion within which the fingers 5 move in a circular manner inside the circle 61 around which the rollers 7 move, and then a rectilinear path portion again, within which the fingers 5 move in a rectilinear manner while the rollers 7 of the support plate 6 cross these fingers 5 again.

FIG. 2 also shows that a base 16 that is able to move with respect to a frame 17 makes it possible to control the position of the set of elements of the device relative to the drum and thus to the blank and also makes it possible to control the pressure with which the undulating strip 21 is pressed against the surface of the blank by the rollers. The stitching means, in this case in the form of a pressing roller 30, are also carried by the movable base 16, for example by way of a pneumatic cylinder 31 (see also FIG. 1) that impresses an elastic pressing force thereon. The position of the movable base 16 is in this case controlled by an electric cylinder 19.

A slide 15, which is itself able to move with respect to the base 16, supports the two sprockets 411 and 412 of the continuous transporter. It will be understood that, by slightly moving this slide with respect to the holder of the rotary support plate (and thus with respect to the support plate axis AP), it is possible to vary the height of the waves imposed on the strip. In this way, it is possible to precisely vary the overlength given to the undulating strip. The movement of the slide 15 is in this case controlled by an electric slide cylinder 18. In order to give an indication of the order of magnitude, it is possible to say that an overlength of 50% is obtained when the waves have a height (amplitude) of around 11 mm.

FIG. 3 shows, on a larger scale, the principle of this embodiment relating to the formation of the waves by the cooperation of the fingers 5 and the rollers 7 in the intersecting portion. It also clearly shows the principle of the strip diverter 63 (in the form of a static cam) the function of which is to divert the strip in order to release it from the finger 5 after it has been pressed against the blank (not shown here). To this end, the strip diverter comprises an inclined plane along which the edge of the undulating strip 21 slides. It will be understood that, at this stage of the method, the strip is already joined to the blank.

FIG. 4 shows, on an even larger scale, a detail of this embodiment of the device and particularly of an embodiment of the continuous transporter and the fingers. The pins 413 of the links of the chain 41 support the fingers 5 that are mounted in rotation on said pins by way of ball bearings 414. The fingers 5 are thus free to turn with respect to their supports in order to allow the strip to circulate so as to form its waves by imposing as few forces as possible on the device (and on the strip itself).

FIG. 5 shows, on a large scale, a detail of this embodiment of the invention and particularly of the rollers 7 carried by the rotary support plate 6. The rollers are mounted so as to rotate on the support plate by way of bearings (for example plain bearings). Like the fingers, the rollers are free to turn with respect to their supports in order to allow the strip to circulate so as to form its waves by imposing as few forces as possible on the device (and on the strip itself).

The installation thus makes it possible to implement the method according to the invention that consists in preparing an undulating strip having a controlled overlength, the undulating strip then being wound directly in the undulating form onto the blank of a tire while it is being manufactured. Direct laying on the blank makes it possible to ensure the precision of laying, in particular as far as the value of the overlength of the reinforcers and the regular distribution of this overlength on the circumference of the blank are concerned. A suitable number of turns of the undulating strip are thus wound in a helix in order to form the hoop reinforcement of the tire. This winding can be carried out at the rim seat diameter as described above in the preamble of the application, since the overlength of the reinforcers of the undulating strip then allows the blank to be shaped, that is to say to take the virtually final shape of a tire, before said 0° reinforcers are actually put under tension.

During the helical winding about the blank, it is also possible to vary the value of the overlength of the strip by virtue of the position of the slide 15 being controlled. It is possible for example to provide for the overlength to be less at the centre than at the shoulders of the tread, such that a certain curvature is given to the tire during the shaping of the complete blank.

FIG. 6 schematically shows an example of a tire blank 50 obtained according to the invention. The particular desire here was to show the hoop reinforcement disposed within a blank during the manufacture of a tire. The drum on which the blank has been assembled up to this point is not shown. The 0° reinforcers disposed in the form of an undulating strip 21 as formed by the method of the invention can be seen. The waves of the strip extend in a plane perpendicular to the axis of the blank (ignoring the helix angle of the winding as discussed above). The waves of the strip are thus in a plane parallel to the equatorial plane of the tire which will be obtained from this blank. Around 15 turns have been wound around the blank in order to form the complete hoop reinforcement.

The layer 51 containing the carcass reinforcers and the beads 52 containing the bead reinforcers (often referred to as “bead wires”) can also be seen. Crown reinforcer plies can be placed under the hoop reinforcement. An innerliner layer 53 is preferably present inside the carcass 51. The 0° reinforcer strips are shown here in the undulating form 21 but not stitched (referenced 22 in the above figures) in order to make it easier to read the drawing. It will be understood that the stitched form can be preferred in order to improve the precision of positioning the reinforcers in the rest of the method as described above. A tread and sidewall protection rubbers can then be added to this blank in a manner known per se. All the constituents of the future tire can thus be laid at the same reduced diameter, that is to say on one and the same drum at the rim seat diameter and thus without intermediate shaping.

Alternatively, the laying drum can also have a diameter slightly greater than the rim seat diameter, if it comprises grooves for receiving the beads of the blank. A blank as shown in FIG. 7 is then obtained, instead.

In both cases, once all the constituent elements of a tire have been laid, the complete blank thus formed can then be placed in a vulcanizing press, shaped and then moulded and vulcanized in a manner known per se.

Preferably, the feeding of the device with flat strip is subjected to precise control of its feeding rate. This can be obtained by virtue of the use of a motorized winch 100, as shown in FIGS. 8 and 9. These figures show the flat strip 20 being guided around the pulley 101 of the winch, the rotation of this pulley being controlled by the winch motor 102. Also preferably, a strap 103 stretched between returns 104 presses the strip against the winch pulley in order to prevent it from accidentally slipping. The speed of rotation of the winch, that is to say the speed of the flat plate feeding the device, can be controlled precisely depending on the speed of rotation of the blank in order to just as precisely control the overlength of the reinforcers laid, including in a dynamic manner during the helical winding of the undulating strip, as described above.

In order to adapt to the variations in lengths that are provided by the winch, the offset between the support plate axis AP and the axis of the intersecting sprocket can be adjusted passively by means for example of a simple spring that tends to return the slide 15, or actively by way of management based on a measurement of the effective tension of the strip.

FIG. 10 shows another embodiment of the device for preparing and laying the strip. This device 200 comprises 2 sprockets 201 and 202, the teeth of which mesh and cooperate in order to deform the flat strip 20 and convert it into an undulating strip 21. Preferably, the strip is kept pressed against the bottom of the teeth by a negative pressure prevailing in the channels 203. These channels are under negative pressure as long as they are in communication with the fixed sector 204, which is itself connected to a source of vacuum. The peaks 211 of the waves of the strip are pressed, one by one, against the surface 501 of the blank 50 by the teeth of the sprocket 202 in a comparable manner to the description given above for the device of the preceding figures. Once the peaks have been carried along by the blank, the negative pressure can even be replaced by a slight pressure in order to help the strip to leave the bottom of the teeth.

1-10. (canceled)

11: A method for manufacturing a tire, the method comprising steps of:
continuously converting a flat reinforcing strip into an undulating reinforcing strip;
pressing peaks of waves of the flat reinforcing strip in the undulating reinforcing strip one by one onto a surface of a tire blank that is driven in rotation by a drum about a drum axis; and
winding the undulating reinforcing strip onto the tire blank,
wherein, in the converting step, the flat reinforcing strip is converted into the undulating reinforcing strip in an immediate vicinity of the drum,
wherein the waves of the undulating reinforcing strip and movement of the peaks towards the surface of the tire blank extend in a plane substantially perpendicular to the drum axis, and
wherein the converting step, the pressing step and the winding step are performed successively.

12: The method according to claim 11, wherein the undulating reinforcing strip is wound helically onto the tire blank so as to form, in a plurality of turns, a hoop reinforcement of a crown of the tire, the undulating reinforcing strip having a given overlength that allows the tire blank to be shaped.

13: The method according to claim 11, further comprising a step of stitching by continuously folding down the waves of the undulating reinforcing strip while the undulating reinforcing strip is being wound onto the tire blank, wherein movement in the folding down of the waves towards the surface of the tire blank is carried out in a plane substantially perpendicular to the drum axis.

14: The method according to claim 11, wherein a height of the waves is varied during the winding step.

15: An installation for performing a method for manufacturing a tire, the installation comprising:
a rotary drum that rotates about a drum axis, the drum being structured to carry a tire blank; and
a strip handling device that continuously converts a reinforcing strip from a flat form into an undulating form, and that presses peaks of waves of the strip in the undulating form one by one onto a surface of a tire blank that is driven in rotation by the drum, the strip handling device including:
a continuous transporter that is able to guide a plurality of fingers along a closed circuit, the fingers being structured to bear against a first face of the strip,
a rotary support plate that rotates about a support plate axis, the rotary support plate being structured to carry a plurality of rotary rollers having axes parallel to the support plate axis, the rollers being distributed in a circle substantially concentric with the support plate axis, and the rollers being structured to bear against a second face of the strip,
a guide portion structured to guide the strip in the flat form entering the strip handling device, and
a synchronizer that synchronizes a rotation of the rotary support plate and a forward motion of the continuous transporter,
wherein the closed circuit has an intersecting portion at which the synchronizer allows the fingers and the rollers to move in rotational movements in a common plane perpendicular to the support plate axis, the fingers and the rollers being interposed at the intersecting portion so as to form the waves on the strip, the waves extending in the common plane, and
wherein the strip handling device is positioned next to the drum.

16: The installation according to claim 15, wherein the continuous transporter is a chain guided by an intersecting sprocket in the intersecting portion of the closed circuit.

17: The installation according to claim 16, wherein the fingers are carried by pins of links of the chain.

18: The installation according to claim 15, wherein the strip handling device further includes a static strip diverter positioned at the intersecting portion and structured to divert the strip from the fingers.

19: The installation according to claim 18, wherein the static strip diverter diverts the strip from the fingers at least a quarter turn after a starting part of the intersecting portion.

20: The installation according to claim 15, wherein the strip handling device further includes a stitcher that stitches the strip in the undulating form.

21: The installation according to claim 15, wherein the strip handling device further includes a motorized winch that controls a supply of the strip in the flat form to the strip handling device.
